(19) United States
(12) Patent Application Publication
(10) Pub. No.: US 2006/0198524 A1
(43) Pub. Date: Sep. 7, 2006

(54) Hardware implementation of the mixcolumn/invmiscolumn functions

(76) Inventor: Bonnie C. Sexton, Cary, NC (US)

Correspondence Address: PHILIPS INTELLECTUAL PROPERTY & STANDARDS, P.O. BOX 3001, BRIARCLIFF MANOR, NY, 10510, US

(21) Appl. No.: 10/556,329

(22) PCT Filed: May 10, 2004
(86) PCT No.: PCT/IB04/01480

§ 371 Date: Nov. 10, 2005

Related U.S. Application Data
(60) Provisional application No. 60/470,391, filed on May 14, 2003.

(51) Int. Cl. H04L 9/00

(52) U.S. Cl. 380/277

(57) ABSTRACT

An encryption/decryption unit, a conversion module, a method and a computer program product share common logic for both a cipher transformation and an inverse cipher transformation to reduce the number of gates requires with a small increase in wait time. A keyschedule unit providing at least one key value. The conversion module, which is in communication with the keyschedule unit, converts a block of plain text/ciphered text into a predetermined number of byte units in a first plurality of columns. The conversion module includes a MixColumnAll submodule that utilizes shared circuitry for both a transformation of a cipher function to produce a second plurality of columns from the first plurality of columns, and for an inverse cipher function to produce the first plurality of columns from the second plurality of columns. The MixColumnAll submodule performs a combined MixColumn and InvMixColumn that are performed in AES. A block round unit for encrypting/decrypting the predetermined number of byte units into ciphered text/plain text.

The present invention relates to methods and apparatuses to perform encryption. More particularly, the present invention relates to an improvement in the Mix Column function as it functions in different methods of encryption, such as the Advanced Encryption Standard (AES).

### DESCRIPTION OF THE RELATED ART

With the increase in use of items such as Smartcards and commerce transacted over the Internet, the need to encrypt and decrypt data has never been more critical than in the present. In fact, the U.S. government, particularly through the National Institute of Standards and Technology (NIST) has for many years chosen encryption standards, such as DES (Data Encryption Standards) that was selected back in 1976 as the U.S. standard, and Triple DES subsequently became the standard. In recent years, the NIST has been evaluating a plurality of AES algorithms in order to select a new standard under AES that would be the official encryption standard. Joan Daemen and Vincent Rijmen presented a cryptographic algorithm that has been approved by the NIST, and published same on Nov. 26, 2001. This algorithm is referred to as the Rijndael algorithm. AES uses three systems of 128, 192 and 256 bits so as to improve the 56 bit encryption of the prior art in terms of performance, flexibility, efficiency and an easier way to embody.

The basic unit for processing in the AES algorithm is a byte. Internally, the AES algorithm's operations are performed on a two-dimensional array of bytes called the STATE. The STATE generally has four rows of bytes, each containing Nb bytes, where Nb is the block length divided by 32.

Encryption converts data to an unintelligible form called cipher text. Decryption of the cipher text converts the data, which is referred to as “plaintext”, back into its original form. Common terminology in the art refers to the series of transformations that converts plaintext to cipher text as “Cipher”, whereas the series of transformations that converts cipher text to plaintext is referred to as “Inverse Cipher.” In both Ciphering and inverse ciphering, a Cipher Key, which is a secret cryptographic key that is used by an Expansion Key Routine, generates a series of values (called round keys) that are applied to the STATE in the Cipher and Inverse Cipher routines.

The input and output for the AES algorithm each consists of sequences of 128 bits (digits with values of 0 or 1). These sequences will sometimes be referred to as blocks, and the number of bits that they contain will be referred to as their length.

AES uses the MixColumn transformation along with some other transformations to decrypt (decipher) and encrypt (encipher) information. MixColumn in the Cipher takes all of the columns of the STATE and mixes their data (independently of one another) to produce new columns. InvMixColumn is a transformation of the Inverse Cipher that is the inverse of MixColumn.

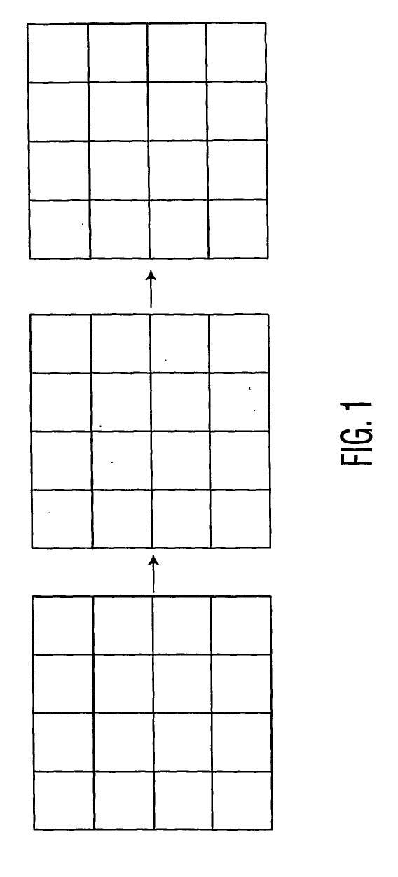

FIG. 1 illustrates an example of a STATE array input and output. At the start of the Cipher and Inverse Cipher, the input array of bytes (in₀ to in₁₅) is copied into the STATE as shown in FIG. 1. The Cipher or Inverse Cipher operations are then conducted on this STATE array, after which its final value is copied to the array of output bytes out₀ to out₁₅.

In the prior art, hardware implementations are such that the Inverse Cipher can only partially re-use the circuitry that implements the Cipher. It would desirable to have a method and apparatus in which a single circuit performs the normal and Inverse MixColumn algorithms, reducing the total gate count required and thus decreasing the size of the total circuitry.

The present invention provides a sharing of most of the circuitry used for the MixColumn function and Inverse MixColumn function that result in a reduced gate count. For high-speed networking processors and Smart Card applications a smaller gate size and a high data rate are provided. The present invention provides a gate size so small parallel processing can be utilized without greatly increasing the die size, as increased die size adds more expense and power consumption of the device. In the present invention the maximum path delay is not significantly longer than prior art devices yet allows for significantly smaller circuit designs. The present invention implements a function heretofore unknown in the art, referred to by the inventor as “MixColumnAll”, and the circuit performs both the MixColumn and InvMixColumn transformations with very little duplicate logic.

The present invention also includes a method for performing the MixColumnAll function, and a computer program that executes the MixColumnAll function as part of an encryption/decryption process.

The above and other features and advantages of the present invention will become more apparent from the following detailed description when taken in conjunction with the accompanying drawings, in which:

FIG. 1 illustrates a STATE array and its input and output bytes.

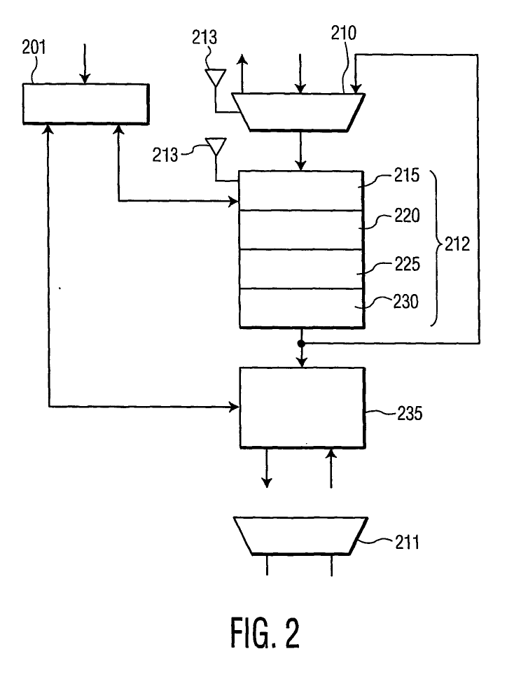

FIG. 2 illustrates one way that an apparatus according to the present invention can be arranged.

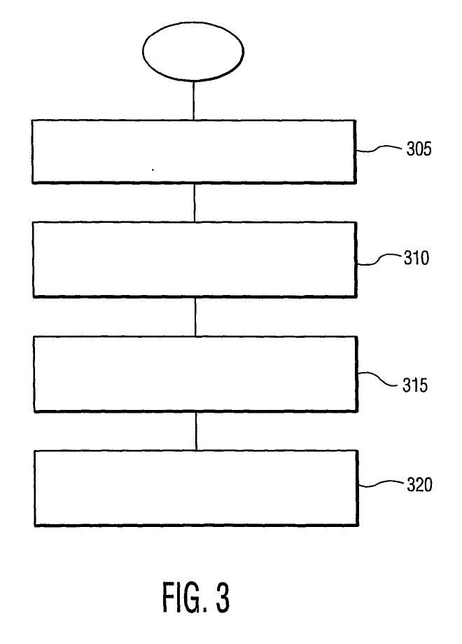

FIG. 3 is a flow chart providing an overview a method according to the present invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

With regard to FIG. 1, as disclosed in “FIPS 197” by NIST, at the start of the Cipher and Inverse Cipher, the input, which is the array of bytes in₀ to in₁₅, is copied into the STATE array as shown. The Cipher or Inverse Cipher operations are then conducted on this State array, after which its final value is copied to the output, which is shown as the array of bytes ranging from out₀ to out₁₅. The addition of two elements in a finite field is achieved by “Adding” the coefficients for the corresponding powers in the polynomials for the two elements. The addition is performed with Boolean exclusive-or (XOR) operations (“FIPS 197”, NIST, p. 10). Shown below is a binary notation example for adding two bytes:
{01010111}⊕{1000011)={11010100}. eqn (1.0)
In the polynomial representation, multiplication in GF(2⁸) corresponds with the multiplication of polynomials modulo an irreducible polynomial of degree 8. A polynomial is irreducible if
Its only divisors are one and itself. For the AES algorithm, this irreducible polynomial is
M<x>=x⁸+x⁴+x³+x+1. eqn. (1.1)

A diagonal matrix with each diagonal element equal to 1 is called an identity matrix. An identity matrix is denoted In:

$$In = [ \begin{matrix}10000 \\ 01000 \\ 00100 \\ 00010 \\ 00001\end{matrix} ] \qquad eqn . ( 1.2 )$$

If A and B are n×n matrices, we call each an inverse of the other if:
AB=BA=Iₙ (1.3)

The MIXCOLUMN ( ) transformation operates on the State column-by-column, treating each column as a four-term polynomial. The columns are considered as polynomials over GF (2⁸) and multiplied modulo x⁴+1 with a fixed polynomial a(x), as disclosed by FIPS, NIST, at page 17:
A(x)={03}x³+{01} X²+{01}x+{02};

This can be written as a matrix multiplication shown below:

$$\overline{[ \begin{matrix}{s}^{′} ( 0 , c ) \\ {s}^{′} ( 1 , c ) \\ {s}^{′} ( 2 , c ) \\ {s}^{′} ( 3 , c )\end{matrix} ]} [ \begin{matrix}02020101 \\ 01020301 \\ 01010203 \\ 03010102\end{matrix} ] [ \begin{matrix}s ( 0 , c ) \\ s ( 1 , c ) \\ s ( 2 , c ) \\ s ( 2 , c )\end{matrix} ] \qquad ( 1.4 )$$

As a result of this multiplication, the four bytes in as column are replaced by the following:
^{s}(0, c)=^{({02}•s}(0, c)^{)⊕({03}•s}(1, c)^{)⊕s}(2, c)^{⊕s}(3, c)
^{s}(1, c)=^{s}(0, c)^{⊕({02}•s}(1, c)^{)|({03}•s}(2, c)^{⊕s}(3, c)
^{s}(2, c)=^{s}(0, c)⊕^{s}(1, c)^{⊕({02}•s}(2, c)^{⊕({03}•s}(3, c)⁾
s(3, c)=^{({03}•s}(0, c)^{)⊕s}(1, c)^{⊕s}(2, c)^{({02}•s}(3, c)⁾ eqn. (1.5)

The inverse of MixColumn is similar to the normal MixColumn. Every column is transformed by multiplying it with a specific multiplication polynomial d(x), divided by the following:
D(x)={0B}x³+{0D}x²+{09}x+{09} eqn. (1.6)

Equation 1.6 is from “The Rijndael Cipher Block”, Daemen and Rijmen, page 13.

The present invention uses a circuit that implements both normal and inverse transforms resulting in a reduced combinational logic implementation for the MixColumn transformation. This implementation is smaller in the total gate count with a slightly longer maximum delay path than the separate prior art MixColumn and InvMixColumn transformations.

The C code to implement the prior art MixColumn is given by Daemen and Rijmen as follows:

Void MixColumn (word8 a[4] [MAXBC],word8 BC) {

/* Mix the four bytes of every column in a linear way */

word8 b[4] [MAXABC];
int I, j;
for (j=0; j < BC′ j++)

for (i=0; i<4; i++)

b [i] [j] = mul (2,a [i] [j])

\hat{ }mul (3, a [(I + 1) % 4] [j])
\hat{ }a[ (I + 2) % 4] [j]
\hat{ }a[ (1 + 3) % 4] [j];

for (i=0; i<4; i++)
for (j=0; j < BC; j++) a [i] [j] = b [i] [j];

Note: Function mul is the GF(2⁸) multiplication.

In addition, the C code to implement the prior art Inverse MixColumn is given by Daemen and Rijmen as follows:

void InvMixColumn (word8 a[4] [MAXABC], word8 BC) {
/* Mix the four bytes of every column in a linear war
/* This is the opposite operation of MixColumn
*/
word8 b [4] [MAXABC];
int I, j;
for (j= 0; j < BC; j++)
for (i= 0, I < 4; i++)

b [i] [j] = mul (0xe, a [i] [j])
\hat{ }mul (0xb, a [ (i + 1) % 4 ] [j] )
\hat{ }mul (0xd, a [ (i + 2) % 4 ] [j] )
\hat{ }mul (0x9, a [ (i + 3) % 4 ] [j] );

for (I = 0; I < 4; i++)

for (j =0; j < BC; j++) a[i] [j] = b [i] [j]′

If the MixColumn transformations are implemented as suggested by Daemen and Rijmen with AND and XOR gates, the circuit equation would look as follows:

MixColumn Transform Equations:

After Boolean reduction, the equations for one byte are:
Bit 7=b2[7]ˆb3[7]ˆb1[7]ˆb1[6]ˆb0[6]
Bit 6=b3[6]ˆb2[6]ˆb1[5]ˆb1[6]ˆb0[5]
Bit 5=b3[5]ˆb2[5]ˆb1[4]ˆb1[5]ˆb0[4]
Bit 4=b3[4]ˆb2[4]ˆb1[3]ˆb1[4]ˆb0[3]ˆb1[7]ˆb0[7]
Bit 3=b3[3]ˆb2[3]ˆb1[2]ˆb1[3]ˆb0[2]ˆb0[7]ˆb1[7]
Bit 2=b3[2]ˆb2[2]ˆb1[1]ˆb1[2]ˆb0[1]ˆb0[7]
Bit 1=b3[1]ˆb2[1]ˆb1[0]ˆb1[1]ˆb0[0]ˆb1[7]
Bit 0=b3[0]ˆb2[0]ˆb1[0]ˆb0[7]ˆb1[7]

InvMixColumn Transform Equations:

After Boolean reduction, the equations for one byte are:
Bit 7=b2[7]ˆb3[7]ˆb1[7]ˆb1[6]ˆb0[6]ˆb0[4]ˆb0[5]ˆb1[4]ˆb2[4]ˆb2[5]ˆb3[4]
Bit 6=b3[6]ˆb2[6]ˆb1[5]ˆb1[6]ˆb0[5]ˆb0[7]ˆb0[3]ˆb0[4]ˆb1[7]ˆb1[3]
ˆb2[7]ˆb2[3]ˆb2[4]ˆb3[3]ˆb3[7]
Bit 5=b3[5]ˆb2[5]ˆb1[4]ˆb1[5]ˆb0[4]ˆb1[7]ˆb1[2]ˆb2[3]ˆb3[2]ˆb0[3]ˆ
b0[2]ˆb0[6]ˆb1[6]ˆb2[6]ˆb2[2]ˆb3[7]ˆb3[6]
Bit 4=b3[4]ˆb2[4]ˆb1[3]ˆb1[4]ˆb0[3]ˆb1[7]ˆb0[5]ˆb0[1]ˆb1[5]ˆb2[5]ˆ
b2[1]ˆb2[7]ˆb3[5]ˆb0[2]ˆb1[6]ˆb1[1]ˆb2[2]ˆb3[6]ˆb3[1]
Bit 3=b3[3]ˆb2[3]ˆb1[2]ˆb1[3]ˆb0[2]ˆb0[5]ˆb1[5]ˆb2[5]ˆb2[1]ˆb2[7]ˆ
b3[5]ˆb0[0]ˆb0[6]ˆb3[0]ˆb3[7]ˆb2[6]ˆb2[0]ˆb1[0]
Bit 2=b3[2]ˆb2[2]ˆb1[1]ˆb1[2]ˆb0[1]ˆb1[7]ˆb0[0]ˆb0[6]ˆb3[6]ˆb3[7]ˆb2[0]ˆb2[6]ˆb1[6]
Bit 2=b3[1]ˆb2[1]ˆb1[0]ˆb1[1]ˆb0[0]ˆb1[7]ˆb1[5]ˆb3[6]ˆb3[5]ˆb0[5]ˆb2[5]ˆb2[7]ˆb1[6]
Bit 0=b3[0]ˆb2[0]ˆb1[0]ˆb0[7]ˆb1[7]ˆb1[6]ˆb2[5]ˆb3[5]ˆb0[5]ˆb0[6]ˆb2[6]
By an inspection of the two transform equations (MixColumn and InvMixColumn), it is seen that there is a common logic for each bit:
Bit 7=b2[7]ˆb3[7]ˆb1[7]ˆb1[6]ˆb0[6]
Bit 6=b3[6]ˆb2[6]ˆb1[5]ˆb1[6]ˆb0[5]
Bit 5=b3[5]ˆb2[5]ˆb1[4]ˆb1[5]ˆb0[4]
Bit 4=b3[4]ˆb2[4]ˆb1[3]ˆb1[4]ˆb0[3]ˆb1[7]
Bit 3=b3[3]ˆb2[3]ˆb1[2]ˆb1[3]ˆb0[2]
Bit 2=b3[2]ˆb2[2]ˆb1[1]ˆb1[2]ˆb0[1]
Bit 1=b3[1]ˆb2[1]ˆb1[0]ˆb1[1]ˆb0[0]ˆb1[7]
Bit 0=b3[0]ˆb2[0]ˆb1[0]ˆb0[7]ˆb1[7]
Thus, according to the present invention, the above common logic is shared, essentially reducing the number of instantiations in half by combining the inverse and normal transformations into one circuit.
For gate size and maximum path delay we will use a synthesis tool from Synopsys and Philips CMOS18 technology library for comparisons.

Comparisons: The circuits were both designed according to:

(1) the prior art AES proposal (NIST) that uses a separate circuit for the respective normal and inverse logic MixColumn algorithms; and

(2) a single circuit according to the present invention that implements both with shared logic referred to by the Inventors as MixColAll algorithm.

The comparison of sizes and maximum delays were performed on separate MixColumn designs and the MixColAll circuit. Each design is synthesized and time using maximum path analysis. Size in gates are given as well as size in microns for comparisons of both implementations.

Table 1 below shows the comparison of the separate circuit MixColumn and InvMixColumn versus the reduced logic structure of the present invention.

TABLE 1

| | SIZE | | MAXIMUM |
|---|---|---|---|
| IMPLEMENTATION | GATES | Um² | DELAY |
| MixColumn | 1120 | 864.25 | 1.07 |
| | (70 × 16) | (864.25 × 16) | |
| InvMixColumn | 3216 | 2469.88 | 2.25 |
| | (201 × 16) | (2469.88 × 16) | |
| MixColumnAll | 3053 | 9376 | 2.84 |
| | (763.2 × 4) | (9376 × 4) | |

The combined gate size of the separate circuit solution is 1120+3216=4336. The combined gate size is 3053 with a savings of 1283 gates. The maximum delay through the separate circuit is the longest path which is 2.25 ns. The combined circuit maximum delay is 2.84, an increase of only 590 ps. The circuitry used is CMOS, although other types of circuitry could also be substituted.

FIG. 2 is a block diagram illustrating one way that an apparatus according to the present invention could look. It should be understood by persons of ordinary skill in the art that the MixcolAll sub-module 230 can be used with any hardware apparatus capable of processing the Rijndael algorithms, or other types of algorithms in which a MixColumn and InvMixColumn features can be utilized in both pipelining and non-pipelining apparatuses. The apparatus can encrypt/decrypt via the conversion module 212. The conversion module 212 converts the block of data into byte units, and this module 212 includes keyadd 215, substitutional 220, shiftrow 225, and MixColumnAll 230 submodules. A key schedule module 201 provides a key schedule of subkeys from the key to encrypt/decrypt for each of the rounds. When a encryption process is occurring, the subkey value round key is output to module 235, whereas when a decryption process is occurring, the subkey value is provided from an inverse function to the block round module 235.

A input/output module 210 provides for the entry of plain text to be ciphered, or the receipt of encoded text that has been deciphered 210. The output/input module 211 is analogous to module 210 except that it receives the ciphered text, or ciphered text can be input to be deciphered and output as plain text.

FIG. 3 illustrates a method and the steps for a computer program according to the present invention. An attached Appendix provides sample source code showing one way that a program can be executed according to the present invention.

At step 305 at least one block of data is received for encryption decryption. Next, at step 310 the block is converted into byte units by a shared logic MixColAll module. As previously discussed, the MixColAll module performs both the MixColumn function and the InvMixColumn function sharing the same circuitry using the common logic for each of bits 0-7 (Bit 7=b2[7]ˆb3[7]ˆb1[7]ˆb1[6]ˆb0[6]
Bit 6=b3[6]ˆb2[6]ˆb1[5]ˆb1[6]ˆb0[5], Bit 5=b3[5]ˆb2[5]ˆb1[4]ˆb1[5]ˆb0[4],
Bit 4=b3[4]ˆb2[4]ˆb1[3]ˆb1[4]ˆb0[3]ˆb1[7], Bit 3=b3[3]ˆb2[3]ˆb1[2]ˆb1[3]ˆb0[2]
Bit 2=b3[2]ˆb2[2]ˆb1[1]ˆb1[2]ˆb0[1], Bit 1=b3[1]ˆb2[1]ˆb1[0]ˆb1[1]ˆb0[0]ˆb1[7]
Bit 0=b3[0]ˆb2[0]ˆb1[0]ˆb0[7]ˆb1[7]).

At step 315 a sub-key value is provided for each round of encryption/decryption that occurs. Finally, at step 320, the encrypted/decrypted text is output to an output device such as a memory, display, or printout.

It is understood by artisans of ordinary skill that there are various modifications that can be made that do not depart from the spirit of the invention or the scope of the appended claims. For example, the number of bits of common logic used, the layout of the modules and sub-modules of the apparatus, the number of blocks of data converted, the input and output modules, all can be modified according to need. As the present invention is capable of use with security networking processors, secure keyboard devices, magnetic card reader devices, smart card reader devices, and wireless communication applications such as 802.11 devices, the receipt or output of data can be contained within common circuitry or transmitted over RF, fiber optic, microwave, etc. In such cases a transmission and receive capabilities would be included, along with the protocol conversion from the various types of transmission. Further, while the examples show 8 bytes (128 bits), this amount could be increased or decreased according to need, and/or changes in the AES protocol. It should also be noted that terms such as “plain text” and “ciphered text” are terms of art and the encryption/decryption can encompass drawings, photos, illustrations schematics, include voice, video, and/or multi-media data.

1. An encryption/decryption unit, comprising:
a keyschedule unit for providing at least one key value;
a conversion module in communication with the keyschedule unit, said conversion module converts a block of plain text/ciphered text into a predetermined number of byte units in a first plurality of columns;
a block round unit for encrypting/decrypting the predetermined number of byte units into ciphered text/plain text;
wherein said conversion module includes a MixColumnAll submodule that utilizes shared circuitry for both an transformation of a cipher function to produce a second plurality of columns from the first plurality of columns, and for an inverse cipher function to produce the first plurality of columns from the second plurality of columns.

2. The apparatus according to claim 1, wherein the cipher function comprises a MixColumn function according to the Advanced Encryption Standard (AES).

3. The apparatus according to claim 1, wherein the inverse cipher function comprises an InvMixColumn function according to the Advanced Encryption Standard (AES).

4. The apparatus according to claim 1, wherein the predetermined number of byte units equals 8 bytes (128 bits).

5. The apparatus according to claim 1, further comprising an input module for inputting data blocks of plain text/ciphered text, and an output module for storing/displaying an output of ciphered text/plain text.

6. The apparatus according to claim 1, wherein the MixColumnAll submodule includes shared circuitry for the following common logic for each bit:
Bit 7=b2[7]ˆb3[7]ˆb1[7]ˆb1[6]ˆb0[6]
Bit 6=b3[6]ˆb2[6]ˆb1[5]ˆb1[6]ˆb0[5]
Bit 5=b3[5]ˆb2[5]ˆb1[4]ˆb1[5]ˆb0[4]
Bit 4=b3[4]ˆb2[4]ˆb1[3]ˆb1[4]ˆb0[3]ˆb1[7]
Bit 3=b3[3]ˆb2[3]ˆb1[2]ˆb1[3]ˆb0[2]
Bit 2=b3[2]ˆb2[2]ˆb1[1]ˆb1[2]ˆb0[1]
Bit 1=b3[1]ˆb2[1]ˆb1[0]ˆb1[1]ˆb0[0]ˆb1[7]
Bit 0=b3[0]ˆb2[0]ˆb1[0]ˆb0[7]ˆb1[7].

7. The apparatus according to claim 1, wherein the shared circuitry of the MixColumnAll sub-module comprises CMOS gates.

8. The apparatus according to claim 7, wherein a total number of gates used by the MixColumnAll sub-module to perform a MixColumnAll function is less than a total combined number of gates used by a MixColumn function and an InvMixColumn function utilizing separate circuitry.

9. A conversion module for performing ciphering and inverse ciphering of a plurality columns of data for encrypting/decrypting, said module comprising
a MixColumnAll submodule that utilizes shared circuitry for both a transformation of both a cipher function to produce a new columns of data from the plurality of columns of data, and for an inverse cipher function to produce the plurality of columns from the new columns of data.

10. The conversion module according to claim 9, wherein the shared circuitry is provided for 8 or more bits.

11. The conversion module according to claim 9, wherein the shared circuitry is provided for at least 8 bits having the following common Boolean logic for each bit:
Bit 7=b2[7]ˆb3[7]ˆb1[7]ˆb1[6]ˆb0[6]
Bit 6=b3[6]ˆb2[6]ˆb1[5]ˆb1[6]ˆb0[5]
Bit 5=b3[5]ˆb2[5]ˆb1[4]ˆb1[5]ˆb0[4]
Bit 4=b3[4]ˆb2[4]ˆb1[3]ˆb1[4]ˆb0[3]ˆb1[7]
Bit 3=b3[3]ˆb2[3]ˆb1[2]ˆb1[3]ˆb0[2]
Bit 2=b3[2]ˆb2[2]ˆb1[1]ˆb1[2]ˆb0[1]
Bit 1=b3[1]ˆb2[1]ˆb1[0]ˆb1[1]ˆb0[0]ˆb1[7]
Bit 0=b3[0]ˆb2[0]ˆb1[0]ˆb0[7]ˆb1[7].

12. The conversion module according to claim 11, wherein the module includes means for converting plain text/ciphered text received by wireless communication.

13. The conversion module according to claim 12, wherein the wireless communication comprises an 802.11 format.

14. The conversion module according to claim 9, wherein the plurality of columns of data totals at least 128 bits.

15. A method for data encryption/decryption, comprising the steps of:
(a) receiving at least one block of data for encryption/decryption;
(b) converting the at least one block from step (a) into byte units;
(c) providing to a block round unit a key value for encryption/decryption for each round;
(d) outputting the encrypted/decrypted block to an output device;
wherein the converting of at least one block is performed by sharing logic
in common with both a cipher transformation and an inverse cipher transformation.

16. The method according to claim 15, wherein the inverse cipher function comprises an InvMixColumn function according to the Advanced Encryption Standard (AES).

17. The method according to claim 15, wherein the cipher function comprises a MixColumn function according to the Advanced Encryption Standard (AES).

18. The method according to claim 15, wherein the total number of byte units per block equals 8 bytes.

19. A computer program product for encryption/decryption comprising a computer-readable medium of executable instructions for sharing common logic while encrypting/decrypting, said program product comprising
(a) executable instructions for receiving at least one block of data for encryption/decryption;
(b) executable instructions for converting the at least one block of data from step (a) into a predetermined number of byte units, wherein the converting of at least one block is performed by sharing logic in common with both a cipher transformation and an inverse cipher transformation;
(c) executable instructions for providing to a block round unit a key value for encryption/decryption for each round; and
(d) executable instructions for outputting the encrypted/decrypted data block to an output device.

20. The computer program product according to claim 19, further comprising
that the executable instructions in step (b) includes instructions for shared circuitry for the following common logic for each bit:
Bit 7=b2[7]ˆb3[7]ˆb1[7]ˆb1[6]ˆb0[6]
Bit 6=b3[6]ˆb2[6]ˆb1[5]ˆb1[6]ˆb0[5]
Bit 5=b3[5]ˆb2[5]ˆb1[4]ˆb1[5]ˆb0[4]
Bit 4=b3[4]ˆb2[4]ˆb1[3]ˆb1[4]ˆb0[3]ˆb1[7]
Bit 3=b3[3]ˆb2[3]ˆb1[2]ˆb1[3]ˆb0[2]
Bit 2=b3[2]ˆb2[2]ˆb1[1]ˆb1[2]ˆb0[1]
Bit 1=b3[1]ˆb2[1]ˆb1[0]ˆb1[1]ˆb0[0]ˆb1[7]
Bit 0=b3[0]ˆb2[0]ˆb1[0]ˆb0[7]ˆb1[7].

21. The computer program product according to claim 19, wherein the output device comprises a display.

22. The computer program product according to claim 19, wherein the output device comprises a storage device.

23. The computer program product according to claim 19, wherein the output device comprises a printer.

24. The computer program product according to claim 19, wherein the output device receives the encrypted/decrypted data over wireless communication.
